(19) United States
(12) Patent Application Publication
(10) Pub. No.: US 2003/0174329 A1
(43) Pub. Date: Sep. 18, 2003

(54) System and method for aligning a first optical device with an input port of a second optical device

(76) Inventors: Jerry W. Kuper, Pittsford, NY (US); William S. Gornall, Fairport, NY (US)

Correspondence Address: Law Office of Thomas R. Fitzgerald, Suite 210, 16 East Main Street, New York, NY, 14614, US

(21) Appl. No.: 10/389,030

(22) Filed: Mar. 14, 2003

Related U.S. Application Data
(60) Provisional application No. 60/364,109, filed on Mar. 15, 2002.

(51) Int. Cl. G01B 11/00

(52) U.S. Cl. 356/399

(57) ABSTRACT

Broadband light is fed into the input optical fiber and the fiber is placed adjacent an input port of a waveguide device. An aperture plate with a suitably sized aperture is placed between the relevant output ports of the waveguide device and a light intensity detector. The light intensity detector is coupled to an optical power meter that measures the intensity of the light received by the detector. The aperture plate filters out extraneous light emanating from the areas of the waveguide device surrounding the relevant output ports. The detector then receives the incoming light and the power meter measures its intensity. The position of the input optical fiber is then adjusted as required to maximize the intensity of the light received by the detector.

This application claims priority from U.S. Provisional patent application No. 60/364,109 filed Mar. 15, 2002.

### FIELD OF THE INVENTION

The present invention relates to a system and method for manufacturing optical devices. The invention is especially but not exclusively applicable to methods and systems for aligning optical fibers with ports on a waveguide device prior to attachment thereto.

### BACKGROUND TO THE INVENTION

The increasing use of optical devices in telecommunications networks has led to an increase in the demand for such devices as optical waveguides and integrated optical chips. To meet such demands, production methods for these devices are continuously being updated for optimization and improvement. One time and resource consuming task is that of aligning input optical fibers or fiber arrays to input ports on a waveguide device, such as purely optical multiplexers and demultiplexers, prior to permanently attaching the fiber or fiber arrays to the waveguide device. Previous solutions to this problem, such as that disclosed in U.S. Pat. No. 5,970,192, involved the use of high resolution video cameras that are sensitive to specific wavelengths of light. In this process, light of a specific wavelength is introduced into an input fiber that is to be aligned with an input port of a waveguide device. The input fiber is placed adjacent the relevant input port and a video camera sensitive to the specific wavelength of light is focused on one of the output ports. The camera output is fed to a monitor and the position of the input fiber is adjusted until light is detected by the operator observing the monitor.

Clearly, the above described process is tedious and time consuming. Another drawback of the above process is that specialized video cameras sensitive to specific wavelengths of light are prohibitively expensive. Also, they are physically bulky and relatively heavy which precludes mounting them upon high precision robotic platforms used to assemble optical components such as AWGs. Furthermore, to automate the process, sophisticated image analysis software is required to analyze the video image. The use of such complex software increases the amount of time and resources required for the alignment process. A faster, more inexpensive, and more robust solution to the above problem of detecting the light output from the output ports, and, concomitantly, the alignment of the input fiber to the input port, is therefore required.

### SUMMARY OF THE INVENTION

According to one aspect of the present invention, there is provided a system for aligning a first optical device with a second optical device having at least one input port and at least one output port interconnected by an optical path within the second device, the system comprising:

positioning means for effecting relative displacement between the first optical device and at least one input port of the second optical device while the first optical device is emitting light towards the at least one input port of the second optical device;

reception means for receiving a corresponding optical signal from the at least one output port

measuring means coupled to the reception means for measuring an intensity of the optical signal from the at least one output port;

an apertured member between the at least one output port of the second optical device and the reception means such that the optical signal from the at least one output port passes through an aperture in the member is received by the detector, spacing of the member from the second optical device and the reception means and the sizes of the aperture and reception means being dimensioned so as to limit a field of view of the reception means;

wherein the positioning means is operable to adjust the relative displacement between the first optical device and at least one input port of the second optical device so as to maximize the intensity of the optical signal received by the reception means.

The reception means may comprise a photosensor, for example a photodiode, positioned to receive the optical signal directly and passing a corresponding electrical signal to the measuring means. Alternatively, the reception means may comprise a waveguide or other collector for receiving the optical signal from the output port and conveying it to such a photosensor.

Within the context of this document, the term “light” is intended to include all forms of radiation suitable for communications purposes. This includes but is not limited to visible light, ultraviolet radiation, and infrared radiation. Furthermore, the term “optical signal” is defined for this document to include all forms of optical communications including signals and radiation used for communications including laser light, ultraviolet radiation, infrared radiation, and visible light.

According to another aspect of the present invention, there is provided a method for aligning a first optical device with an input optical port of a second optical device, the second optical device having at least one output optical port connected to the input port by an optical path within the second optical device, the method comprising:

a) positioning the first optical device adjacent to the input optical port of the second optical device and transmitting an optical signal from the first optical device towards the input port of the second optical device;

b) positioning reception means to receive a corresponding optical signal from the at least one output optical port via an aperture in a member disposed between the at least one output port and the reception means, the spacing of the member from both the second optical device and the reception means and the sizes of the aperture and reception means being such as to limit a field of view of the second optical device by the reception means;

c) measuring the intensity of said corresponding optical signal; and

d) adjusting a position of the first optical device relative to the input optical port of the second optical device so as to maximize the intensity of said corresponding optical signal.

In a preferred embodiment, the input optical device is an optical fiber and the second optical device is a waveguide device. Broadband light is fed into the input optical fiber and the fiber is placed adjacent an input port of the waveguide device. An aperture plate with a suitably sized aperture is placed between the relevant output ports of the waveguide device and a photodetector. The light intensity detector is coupled to an optical power meter that measures the intensity of the light received by the detector. The detector then receives the incoming light and the power meter measures its intensity. The position of the input optical fiber is then adjusted as required to maximize the intensity of the light received by the detector, conveniently using a spiral or other search pattern.

The aperture plate filters out extraneous light emanating from the areas of the waveguide device surrounding the relevant output ports, i.e., light which has not necessarily passed through the optical path to exit from the output port but rather has passed thorough surrounding parts of the waveguide device, perhaps when the input fiber was far from alignment with the input port of the waveguide device, for example at an outer part of the spiral search pattern.

### BRIEF DESCRIPTION OF THE DRAWINGS

A better understanding of the invention will be obtained by considering the detailed description of a preferred embodiment described by way of example below, with reference to the following drawings in which:

FIG. 1 is a schematic view of a system according to a first embodiment of the invention;

FIG. 2 is a close-up view of a portion of FIG. 1 documenting the dimensions of elements of the system;

FIG. 3 is a schematic view of a system similar to FIG. 1 with a multimode optical fiber added;

FIG. 4 is a schematic view of a system similar to FIG. 3 with the multimode optical fiber positioned at an angle to the direction of propagation of an optical signal from the output ports;

FIG. 5 is a schematic view of a system similar to FIG. 3 with the multimode optical fiber being replaced by an integrating sphere;

FIG. 6 is a schematic view of a system similar to the system in FIG. 1 with the addition of a control computer and a control line between the control computer and the adjustable platform; and

FIG. 7 is a graph which plots the power meter readings as the input fiber approaches, reaches, and overshoots alignment with an input port.

### DETAILED DESCRIPTION

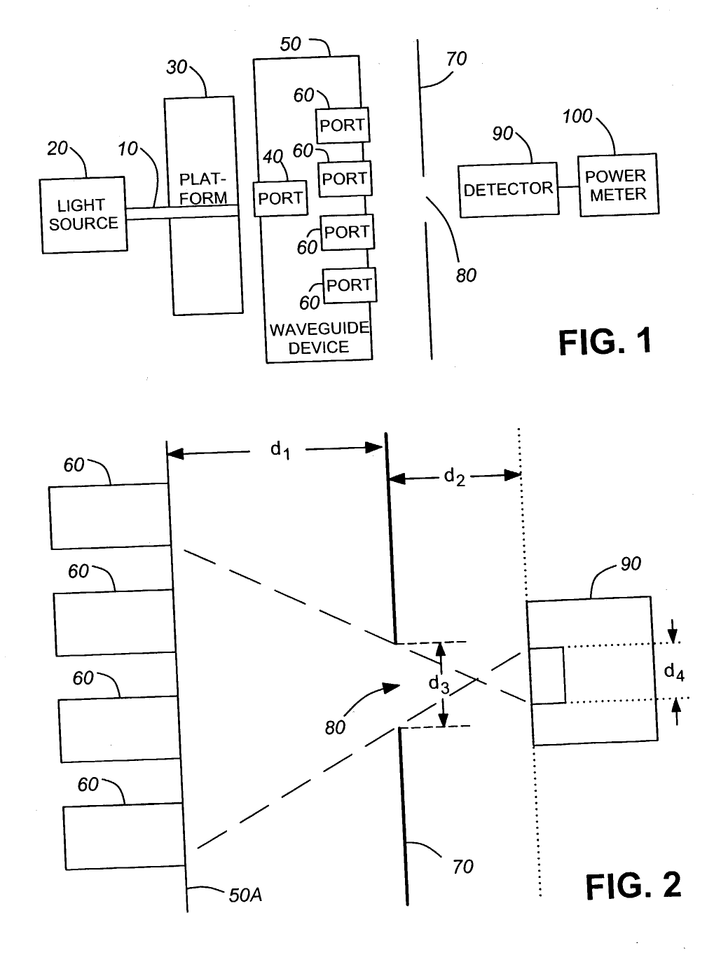

Referring to FIG. 1, a schematic view of a system according to an embodiment of the invention is illustrated. One end of an input optical fiber 10 is coupled to a light source 20. The input optical fiber 10 is placed on an adjustable platform 30 so that an output end of the input optical fiber 10 is adjacent an input port 40 of a waveguide device 50. The waveguide device 50 transmits light received at the input port 40 to at least one of a plurality of output ports 60. An apertured plate 70 has an aperture 80 and is placed between the output ports 60 and a photodetector 90, specifically a photodiode, which converts the optical signal to an electrical signal. The detector 90 is coupled to an optical power meter 100 that measures the electrical signal and hence the intensity of any light passing through aperture 80 and being received by the detector 90.

The system in FIG. 1 works thus: broadband light, i.e., an input optical signal, is emitted from the light source 20 and is transmitted to the input optical fiber 10. The fiber 10 directs the light into the input port 40. Any light entering input port 40 is transmitted to at least one of the output ports 60. The corresponding light from the output ports 60 then illuminates the aperture plate 70 such that at least a portion of the light passes through the aperture 80. This portion of the light is then received by the detector 90. The power meter 100 measures the intensity of this light received by the detector 90.

To optimize the alignment between the input fiber 10 and the input port 40, the adjustable platform 30 is adjusted to change the position of the fiber 10 relative to the input port 40. This adjustment continues until the intensity of the light received by the detector 90 is at a maximum. The adjustment can be along any of the 3 coordinate axes (x, y, z axes) or about any of the attitude axes (roll, pitch, yaw).

Referring to FIG. 2, the dimensions relating to the system are illustrated. As can be seen, a separation distance of d₁ separates the waveguide device face 50A from the aperture plate 70. A second separation distance d₂ separates the aperture plate 70 from the detector 90. The aperture 80 has a diameter d₃ while the detector 90 has a light receiving face diameter of d₄. The aperture 80 can be a round hole but other configurations such as an elongate aperture or slit can be used instead. If a slit configuration is used, the longitudinal axis of the slit is preferably parallel to the line through the centers of the output ports 60 of the waveguide device 50. The preferred dimensions for optimum results are as follows:

d₁=2 mm (but can be up to 10 mm)

d₂=18 mm (but can be from 15 to 22 mm)

d₃=1 mm (but can be up to 3 mm)

d₄=0.2 mm (but can be from 0.01 to 0.2 mm)

It should be noted that the dimensions involved for the waveguide device 50 are fairly small. The output ports 60 are typically square in cross-sectional shape having a dimension of 5 micrometers per side. Typical separation distance between these output ports is about 127 micrometers or 250 micrometers. Using the dimensions listed above, if the output ports 60 are separated by 127 micrometers, the detector 90 is capable of collecting light from about 8 or 9 ports. If the spacing is 250 micrometers, the detector 90 can collect light from about 4 or 5 ports.

If a slit configuration is used as an aperture, favorable results have been obtained using the preferred dimensions given above in conjunction with a 0.1 mm×2 mm slit. As noted above, the longitudinal axis of the slit should be parallel to the line of the output ports.

It should be noted that other dimensions may be used for the distances mentioned above. However, the dimensions must be such that minimal extraneous light emanating from areas of the waveguide device surrounding the output ports 60 reaches the detector 90. Essentially, the aperture 80 in the aperture plate 70 acts as a spatial filter to any light coming from the waveguide device 50. Only a portion of this light, primarily that emitted from the output ports 60, should reach the detector 90.

The aperture plate 70 is preferably thin and light absorbent to prevent any spurious reflections off the aperture edges to the detector. Favorable results have been obtained using a black anodized metal aperture plate.

The detector 90 may be an InGaAs (indium gallium arsenide) or Ge (germanium) photodiode sensitive to light having a wavelength in the region of 1500 nm.

While FIGS. 1 and 2 illustrate direct optical coupling between the output ports and the detector through the aperture 80 in the aperture plate, other configurations, for example those illustrated in FIGS. 3, 4, and 5, are possible.

FIG. 3 illustrates the system in FIG. 1 with the addition of a multimode optical fiber 110 having one end coupled to the detector 90 and having its other end positioned to receive the light output from the output ports 60 of the waveguide device 50. The multimode fiber 110 ideally has a cross-sectional diameter of 200 micrometers (0.2 mm) to match the light receiving face diameter of the detector 90.

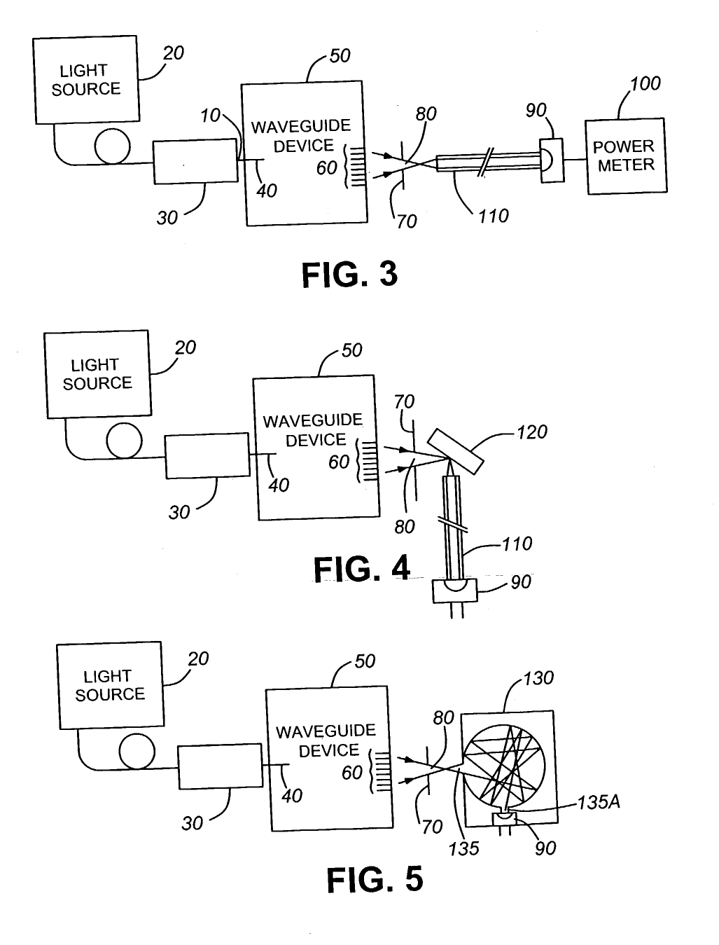

FIG. 4 illustrates another embodiment of the invention in which the multimode fiber 110 extends at an angle to the direction of propagation of the light output from the output ports 60. This light from the output ports is redirected to the multimode fiber 110 by means of an angled mirror 120. The dimensions of the individual components involved in this configuration are similar to those for the configuration in FIG. 3. This configuration illustrated in FIG. 4 would be useful for applications where physical space, specifically overall length, would be at a premium, however, because the path of the light output from the waveguide device 50 is angled due to the mirror 120, the system in FIG. 4 requires less longitudinal space than the system in FIG. 3. The requirement in the system of FIG. 3 that the waveguide device 50 (sometimes an optical multiplexer/demultiplexer), the aperture plate 70, and the detector 90 be in a straight line is no longer a requirement for the system in FIG. 4.

Clearly, however, the mirror 120 in the system of FIG. 4 must be a high-quality mirror or other reflector useful for laser based communications and other optical applications. It should also be clear that the mirror 120 be positioned such that the light output from the output ports 60 is redirected into the multimode fiber 110. Thus, if the fiber 110 extends at 90 degrees to the direction of the light output from the output ports 60, then the mirror 120 should be angled at 45 degrees to the same direction. Other angles and arrangements using the same equipment are possible.

Another configuration that may be used is that illustrated in FIG. 5. The configuration in FIG. 5 uses an integrating sphere 130 between the aperture 80 and the detector 90. The sphere 130 has a first small aperture 135 that is aligned with the aperture 80 of the aperture plate 70 to receive the light from the output ports 60 and a second small aperture 135A spaced from it by about 90 degrees. The detector 90 is positioned at the aperture 135A to receive the light that is reflected within the integrating sphere 130. The combination of the aperture plate 70 and the small aperture 135 of the integrating sphere 130 restricts light collection to a narrow range of angles.

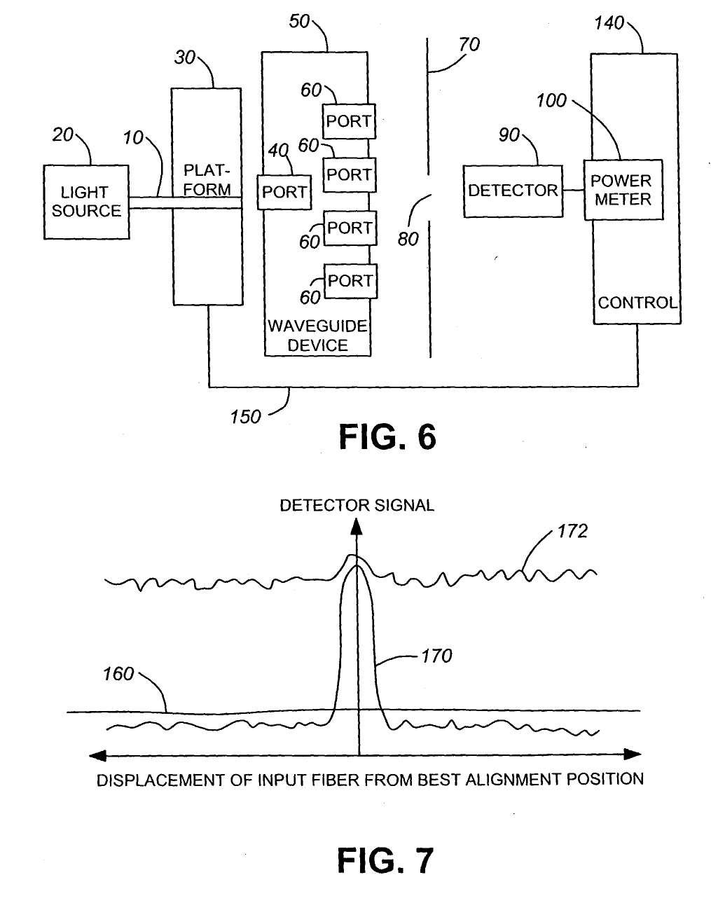

Any of the configurations and arrangements in FIGS. 1, 3, 4 and 5 can be used to detect alignment between the input fiber 10 and the input port 40. Adjustments to the adjustable platform 30 may be made manually, with each adjustment being made prior to each power meter reading. The system may also be automated such that the power meter reading is sampled by a control computer that controls the adjustments to the adjustable platform 30. Such a system with an automated feedback control mechanism is illustrated in FIG. 6. As can be seen, the system in FIG. 6 is very similar to that illustrated in FIG. 1 except that the system in FIG. 6 has a control computer 140 coupled by control line 150 to the adjustable platform 30. The adjustable platform 30 can be any suitable industrial robot with 6 axes of freedom, such as the Burleigh Model FR-3000. Such a robot can provide the required flexibility and adjustability that the aligning application requires. The control computer 140 can be any suitable computer/controller configured such that it can interface with both the power meter 100 and the platform 30. Essentially, the control computer 140 receives or samples the reading of the power meter 100 of the intensity of the light received by the detector 90 from the output ports 60. Based on this reading, and on the previous readings, the control computer 140 sends commands to the adjustable platform 30 to adjust the position of the input fiber 10 relative to the input port 40. This adjustment can be translational along any of the 3 coordinate axes (x, y, and z) or it can be rotational about any of the 3 attitude axes (roll, pitch, yaw). After adjustment, the control computer 140 again samples or reads the output of the power meter. The process is continued for each of the 6 axes to optimize the alignment of the input fiber 10 with the input port 40. Optimum alignment between the two is theoretically achieved when the intensity of the light being received by the detector is at a maximum.

The basis for automating the above process can be seen in the graph of FIG. 7. The graph plots the power meter readings or the detector signal along a single axis as the input fiber 10 approaches, reaches, and overshoots alignment with an input port 40. As can be seen, the use of an aperture plate 70 and a small area detector 90 causes a large spike 170 in the power meter reading when the input fiber 10 is optimally aligned with the input port 40. This spike 170 can be contrasted with the detector signal 172 when an aperture plate 70 is not used. The increase in the detector signal 172 is barely noticeable above the background optical noise. In contrast, the spike 170 is clearly discernible when an aperture plate 70 is used.

The large spike 170 is caused by the aperture plate 70 filtering out light emanating from areas of the waveguide device surrounding the output ports. In doing this, large amounts of background optical “noise” that would normally be received by the detector from these areas are not received by the detector. A threshold 160 can be arbitrarily set to distinguish the readings from the background light received by the detector 90.

The software which will run and control both the control computer 140 and the adjustable platform 30 should search for this spike 170 in the readings to optimize the alignment between the input fiber and the input port. It should be clear that logic followed by the software must discount the background readings and “search” for the spike 170 in the readings. Furthermore, the searching for the spike 170 must continuously adjust the settings of the adjustable platform 30 to change the position of the input fiber 10 relative to the input port 40. In one search method, the software moves the input fiber platform 30 in directions (x and y) perpendicular to the axis (z) of the fiber 10 to perform a so-called raster scan, while continuously reading the power meter readings.

Another search method uses a rectangular spiral scan over the x and y axes. In a rectangular spiral scan, the position of the platform 30 is adjusted by a given amount along one of the Cartesian coordinate planar axes (x or y axis). The position of the platform 30 is adjusted by a given amount along the other of the Cartesian coordinate planar axes not chosen in the previous step. The next step is to adjust the position of the platform 30 in a direction parallel, but opposite, to the direction of the first adjustment. This third adjustment has a predetermined value greater than the first adjustment. The next adjustment adjusts the platform 30 in a direction opposite to, but parallel to, and greater than, the second adjustment. The process continues as the readings are continuously scanned for the spike 170. As can be visualized, the path of the platform 30 defines an outwardly progressing spiral with squared edges in the x-y plane. Once the readings exceed the threshold level indicating that the spike 170 is found, a search for the peak of the spike 170 is initiated. This involves increasing the settings for the adjustable platform until the peak is reached or passed. The settings are then incrementally decreased or reduced until the maximum reading is once again found.

To simplify the searching/optimization process after the spike 170 is found, the software can be configured to optimize the alignment for one axis at a time. Thus, the software can choose the translational x-axis and optimize the alignment of the input fiber 10 to the input port 40 relative to this axis. The settings for the translational x-axis are adjusted until the maximum reading is found. The software then fixes the setting for the x-axis to the setting that produced the highest reading. Another axis can then be chosen and the alignment optimized for this next axis. The process continues until the alignment has been optimized for all axes. In each case, the maximum may be found using one of a number of well-known so-called “hill climbing” techniques for finding the maximum of a signal dependent upon one adjustable parameter.

While the above description and discussion notes moving the input fiber relative to the input port, this can be achieved in numerous ways. The input fiber 10 may be mounted on an adjustable platform 30 as illustrated in FIGS. 1, 3, 4 and 5 while the waveguide device 50 is held stationary. Alternatively, the input fiber 10 may be held stationary while the waveguide device 50 is mounted on an adjustable platform 30. In yet another alternative, both the input fiber and the waveguide device can be mounted on separate adjustable platforms, each platform being independently adjustable relative to the other.

Mounting the second optical device upon the movable platform is preferred where the invention is being used in the assembly of three-component devices, in which case, once the input device has been aligned with, and bonded to, the input side of the second optical device, the alignment procedure can continue to align the output ports of the second device with the input ports of a third optical device. For a description of a system in which the input optical device, specifically an array of fibers, is fixed while being aligned with an optical device mounted upon a movable platform, the reader is directed to an application filed contemporaneously herewith and claiming priority from U.S. Provisional application No. 60/364,131. The contents of this co-filed application are incorporated herein by reference.

It should be noted that while the above description and the attached Figures document alignment of an input optical fiber with the input port of a waveguide device, the system may be extended for use in aligning one optical device with another. It should further be noted that while the above invention can be used with all types of radiation used for optical communications such as laser light, infrared and ultraviolet radiation, best results have been achieved using broadband light. This is because the invention is particularly applicable in the manufacture of optical multiplexers/demultiplexers and other optical devices that have waveguide channels that select different wavelengths of light. By using broadband light, the invention can be used for any waveguide device regardless the device's specific wavelength requirements. The portions of the broadband light that do not meet the device's wavelength requirements are merely filtered out by the device. As such, specific equipment is not required for specific waveguide devices.

Although photodiodes are preferred photosensors because they are small, a photodiode array or a photomultiplier could be used instead.

The invention is not limited to use with passive optical devices, such as waveguide devices and fiber input devices, but could be used to align optoelectronic devices requiring precise alignment, e.g. better than +/−1 micron. For example, it is envisaged that the invention could be used to align laser diodes to a focusing lens and then to a fiber optic cable.

The description hereinbefore addresses the alignment of planar lightguide circuits to fiber arrays. Examples of the planar lightguide circuits are (i) arrayed waveguide gratings (AWGs) (ii) optical switches, splitters/combiners (one input channel to N output channels or vice versa) (iii) pitch converters (N input waveguides with a fixed waveguide spacing to N output waveguides with a different waveguide spacing), and (iv) polarization controllers (devices which alter the polarization state of the transmitted light signal).

A person understanding this invention may now conceive of alternative structures and embodiments or variations of the above all of which are intended to fall within the scope of the invention as defined in the claims that follow.

We claim:

1. A system for aligning a first optical device with a second optical device having at least one input port and at least one output port interconnected by an optical path within the second device, the system comprising:
positioning means for effecting relative displacement between the first optical device and at the least one input port of the second optical device while the first optical device is emitting an optical signal towards the at least one input port of the second optical device;
reception means for receiving a corresponding optical signal from the at least one output port of the second optical device
measuring means for measuring an intensity of the corresponding optical signal from the at least one output port;
an aperture member having an aperture, the member being placed between the at least one output port of the second optical device and the reception means such that the optical signal from the at least one output port passes through the aperture and is received by the reception means;
wherein the positioning means is operable to adjust the relative displacement between the first optical device and at least one input port of the second optical device so as to maximize the intensity of the optical signal received by the reception means.

2. A system according to claim 1, wherein the first optical device is an input optical fiber receiving an input optical signal from a light source.

3. A system according to claim 1, wherein the input optical signal is a broadband optical signal.

4. A system according to claim 1, wherein the second optical device is an optical waveguide device.

5. A system according to claim 4, wherein the waveguide device is an integrated optical chip.

6. A system according to claim 4, wherein the waveguide device is an optical multiplexer/demultiplexer.

7. A system according to claim 1, wherein the aperture is a substantially round hole.

8. A system according to claim 1, wherein the aperture is an elongate aperture.

9. A system according to claim 8, wherein the second optical device has at least two output ports and the aperture has a longitudinal axis parallel to a line joining respective centers of the at least two output ports.

10. A system according to claim 1, wherein the reception and measuring means comprise an optical photodiode coupled to an optical power meter.

11. A system according to claim 1, wherein the positioning means can adjust said position along any one of a plurality of axes.

12. A system according to claim 1, wherein the positioning means is an industrial robot coupled to a platform.

13. A system according to claim 1, further including a control computer, the control computer receiving an output of the measuring means and controlling the positioning means to align the first and second optical devices in dependence thereupon.

14. A system according to claim 1, wherein the reception means comprises a detector and optical conduit means, the optical conduit means being positioned between the aperture plate and the detector such that the optical conduit means receives the optical signal from the at least one optical output port and passes the optical signal to the detector.

15. A system according to claim 14, wherein the optical conduit means is an optical fiber coupled to the detector.

16. A system according to claim 15, further including a mirror for redirecting the optical signal to the optical fiber.

17. A system according to claim 14, wherein the optical conduit means is an integrating sphere.

18. A system according to claim 1, wherein said aperture is suitably sized and the aperture member spaced from the output ports and reception means such that said aperture member filters out extraneous light emanating from areas of said second optical device surrounding said at least one output ports.

19. A system according to claim 18, wherein said aperture has a diameter of about 1.0 mm, said aperture plate is spaced apart from said reception means by a distance in the range from about 15 mm to about 22 mm, and from said second optical device output ports by a distance in the range from between 2 mm to 10 mm, and the reception means has a diameter from about 0.01 to 0.2 mm.

20. A method for aligning a first optical device with an input optical port of a second optical device, the second optical device having at least one output optical port and an optical path between the input port and output port, the method comprising:
a) positioning the first optical device adjacent to the input optical port of the second optical device and transmitting an optical signal from the first optical device towards the input port of the second optical device;
b) positioning reception means to receive a corresponding optical signal from the at least one output optical port via an aperture in a member disposed between the at least one output port and the reception means, the spacing of the member from both the second optical device and the reception means and the sizes of the aperture and reception means being dimensioned so as to limit a field of view of the second optical device by the reception means;
c) measuring the intensity of said corresponding optical signal; and
d) adjusting a position of the first optical device relative to the input optical port of the second optical device so as to maximize the intensity of said corresponding optical signal.

21. A method as claimed in claim 20, wherein step d) is automatically executed by a control computer based on measurements of the second optical signal intensity received from the measurement means.
